(19) United States
(12) Patent Application Publication
(10) Pub. No.: US 2022/0231939 A1
(43) Pub. Date: Jul. 21, 2022

(54) MODEL COUNTERFACTUAL SCENARIOS OF SLA VIOLATIONS ALONG NETWORK PATHS

(71) Applicant: Cisco Technology, Inc., San Jose, CA (US)

(72) Inventors: Grégory Mermoud, Venthone (CH); Jean-Philippe Vasseur, Saint Martin d'Uriage (FR); Vinay Kumar Kolar, San Jose, CA (US); David Tedaldi, Zurich (CH)

(21) Appl. No.: 17/153,561

(22) Filed: Jan. 20, 2021

(51) Int. Cl. H04L 12/707; H04L 12/851

(52) U.S. Cl. CPC H04L 45/22; H04L 47/24

(57) ABSTRACT

In one embodiment, a device obtains traffic telemetry data regarding a first path in a network and an alternate path in the network. The device predicts, based on the traffic telemetry data, an amount of traffic for an application that is expected at a particular time. The device makes, based on the traffic telemetry data and on the amount of traffic for the application that is predicted to be expected at the particular time, a counterfactual prediction as to whether the alternate path would violate a service level agreement associated with the traffic, should the traffic be routed via the alternate path at the particular time. The device causes, based on the counterfactual prediction, the traffic for the application to be rerouted from the first path in the network to the alternate path, prior to the particular time.

### TECHNICAL FIELD

The present disclosure relates generally to computer networks, and, more particularly, to model counterfactual scenarios of service level agreement (SLA) violations along network paths.

### BACKGROUND

Software-defined wide area networks (SD-WANs) represent the application of software-defined networking (SDN) principles to WAN connections, such as connections to cellular networks, the Internet, and Multiprotocol Label Switching (MPLS) networks. The power of SD-WAN is the ability to provide consistent service level agreement (SLA) for important application traffic transparently across various underlying tunnels of varying transport quality and allow for seamless tunnel selection based on tunnel performance characteristics that can match application SLAs and satisfy the quality of service (QoS) requirements of the traffic (e.g., in terms of delay, jitter, packet loss, etc.).

Failure detection in a network has traditionally been reactive, meaning that the failure must first be detected before rerouting the traffic along a secondary (backup) path. In general, failure detection leverages either explicit signaling from the lower network layers or using a keep-alive mechanism that sends probes at some interval T that must be acknowledged by a receiver (e.g., a tunnel tail-end router). Typically, SD-WAN implementations leverage the keep-alive mechanisms of Bidirectional Forwarding Detection (BFD), to detect tunnel failures and to initiate rerouting the traffic onto a backup (secondary) tunnel, if such a tunnel exits.

With the recent evolution of machine learning, predictive failure detection in an SD-WAN now becomes possible through the use of machine learning techniques. This provides for the opportunity to implement proactive routing whereby traffic in the network is rerouted before an SLA violation occurs. However, there is also no guarantee that proactively rerouting the traffic onto a new path will result in improved performance, particularly if the new path exhibits even worse QoS metrics than the original path.

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIGS. 3A-3B illustrate example network deployments;

FIGS. 4A-4B illustrate example software defined network (SDN) implementations;

FIG. 5 illustrates an example architecture for evaluating counterfactual routing scenarios in a network;

FIG. 6 illustrates an example plot of the traffic profile along a network path over time; and

FIG. 7 illustrates an example simplified procedure for evaluating counterfactual routing scenarios.

### DESCRIPTION OF EXAMPLE EMBODIMENTS

### Overview

According to one or more embodiments of the disclosure, a device obtains traffic telemetry data regarding a first path in a network and an alternate path in the network. The device predicts, based on the traffic telemetry data, an amount of traffic for an application that is expected at a particular time. The device makes, based on the traffic telemetry data and on the amount of traffic for the application that is predicted to be expected at the particular time, a counterfactual prediction as to whether the alternate path would violate a service level agreement associated with the traffic, should the traffic be routed via the alternate path at the particular time. The device causes, based on the counterfactual prediction, the traffic for the application to be rerouted from the first path in the network to the alternate path, prior to the particular time.

### Description

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

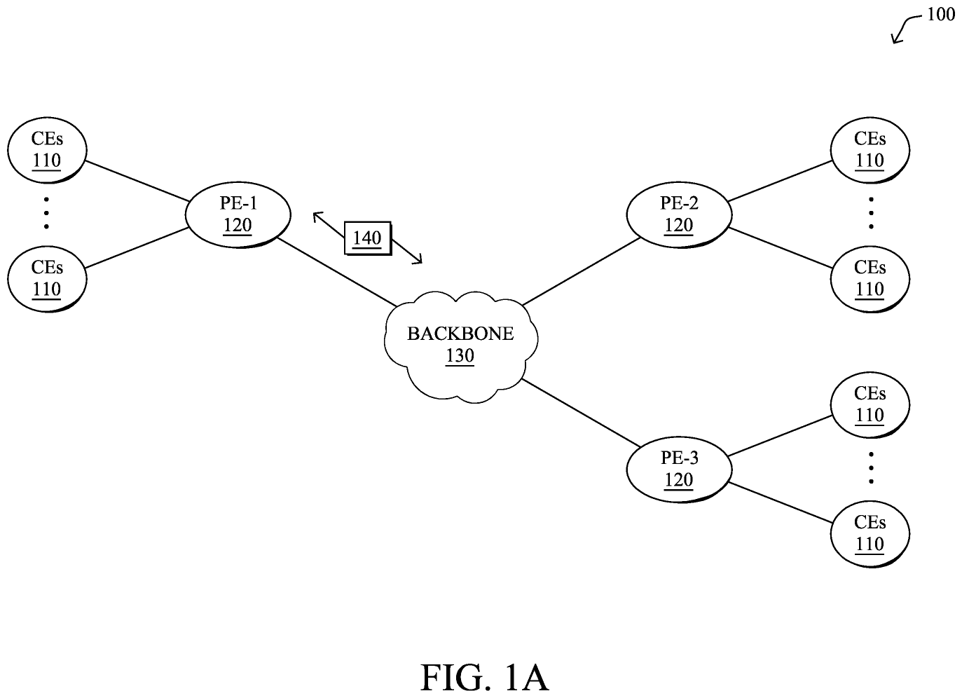

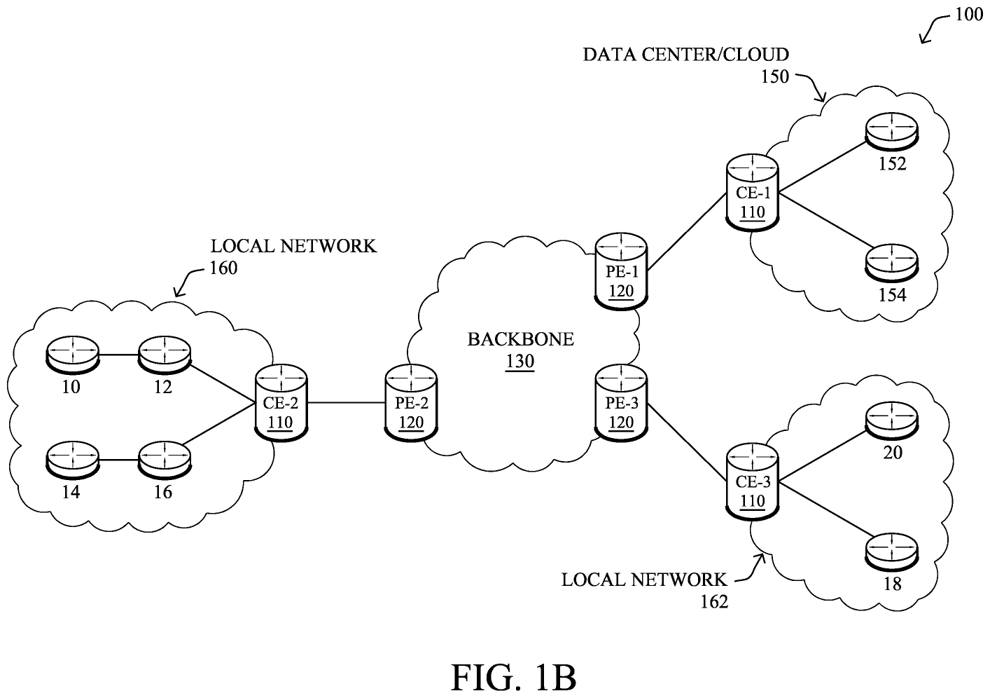

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:

1.) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.

2.) Site Type B: a site connected to the network by the CE router via two primary links (e.g., from different Service Providers), with potentially a backup link (e.g., a 3G/4G/5G/LTE connection). A site of type B may itself be of different types:

2a.) Site Type B1: a site connected to the network using two MPLS VPN links (e.g., from different Service Providers), with potentially a backup link (e.g., a 3G/4G/5G/LTE connection).

2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.

2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).

3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of network 100 in greater detail, according to various embodiments. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

According to various embodiments, a software-defined WAN (SD-WAN) may be used in network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

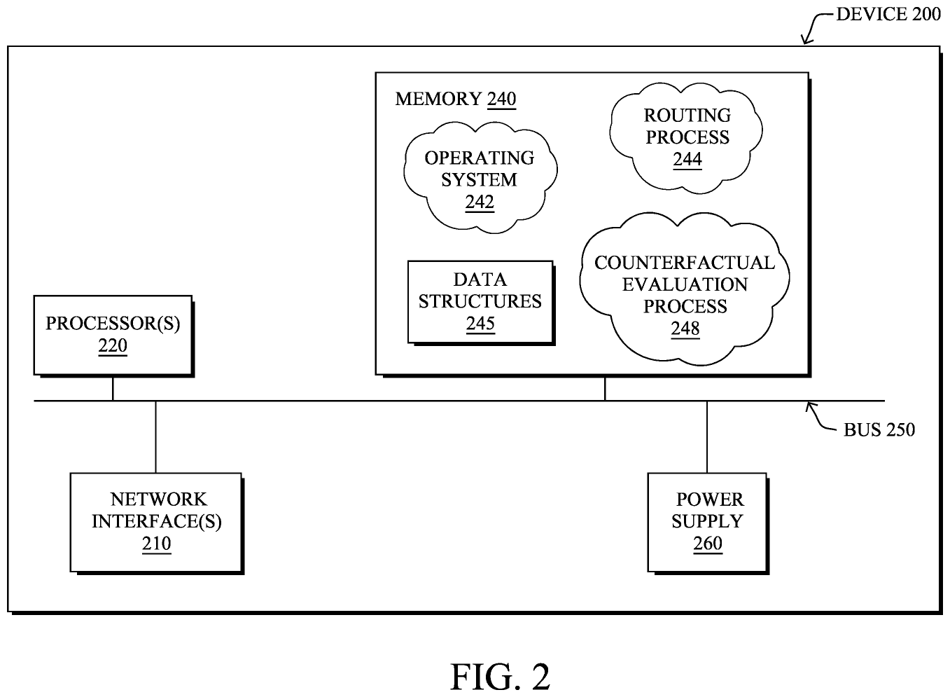

FIG. 2 is a schematic block diagram of an example node/device 200 (e.g., an apparatus) that may be used with one or more embodiments described herein, e.g., as any of the computing devices shown in FIGS. 1A-1B, particularly the PE routers 120, CE routers 110, nodes/device 10-20, servers 152-154 (e.g., a network controller/supervisory service located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise a routing process 244 and/or a counterfactual evaluation process 248, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In general, routing process (services) 244 contains computer executable instructions executed by the processor 220 to perform functions provided by one or more routing protocols. These functions may, on capable devices, be configured to manage a routing/forwarding table (a data structure 245) containing, e.g., data used to make routing/forwarding decisions. In various cases, connectivity may be discovered and known, prior to computing routes to any destination in the network, e.g., link state routing such as Open Shortest Path First (OSPF), or Intermediate-System-to-Intermediate-System (ISIS), or Optimized Link State Routing (OLSR). For instance, paths may be computed using a shortest path first (SPF) or constrained shortest path first (CSPF) approach. Conversely, neighbors may first be discovered (e.g., a priori knowledge of network topology is not known) and, in response to a needed route to a destination, send a route request into the network to determine which neighboring node may be used to reach the desired destination. Example protocols that take this approach include Ad-hoc On-demand Distance Vector (AODV), Dynamic Source Routing (DSR), DYnamic MANET On-demand Routing (DYMO), etc. Notably, on devices not capable or configured to store routing entries, routing process 244 may consist solely of providing mechanisms necessary for source routing techniques. That is, for source routing, other devices in the network can tell the less capable devices exactly where to send the packets, and the less capable devices simply forward the packets as directed.

In various embodiments, as detailed further below, routing process 244 and/or counterfactual evaluation process 248 may also include computer executable instructions that, when executed by processor(s) 220, cause device 200 to perform the techniques described herein. To do so, in some embodiments, routing process 244 and/or counterfactual evaluation process 248 may utilize machine learning. In general, machine learning is concerned with the design and the development of techniques that take as input empirical data (such as network statistics and performance indicators), and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

In various embodiments, routing process 244 and/or counterfactual evaluation process 248 may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as being indicative of an acceptable QoS or an unacceptable QoS. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that routing process 244 and/or counterfactual evaluation process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for time series), random forest classification, or the like.

The performance of a machine learning model can be evaluated in a number of ways based on the number of true positives, false positives, true negatives, and/or false negatives of the model. For example, the false positives of the model may refer to the number of times the model incorrectly predicted that QoS of a particular network path will not satisfy the service level agreement (SLA) of the traffic on that path. Conversely, the false negatives of the model may refer to the number of times the model incorrectly predicted that the QoS of the path would be acceptable. True negatives and positives may refer to the number of times the model correctly predicted acceptable path performance or an SLA violation, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

As noted above, in software defined WANs (SD-WANs), traffic between individual sites are sent over tunnels. The tunnels are configured to use different switching fabrics, such as MPLS, Internet, 4G or 5G, etc. Often, the different switching fabrics provide different QoS at varied costs. For example, an MPLS fabric typically provides high QoS when compared to the Internet, but is also more expensive than traditional Internet. Some applications requiring high QoS (e.g., video conferencing, voice calls, etc.) are traditionally sent over the more costly fabrics (e.g., MPLS), while applications not needing strong guarantees are sent over cheaper fabrics, such as the Internet.

Traditionally, network policies map individual applications to Service Level Agreements (SLAs), which define the satisfactory performance metric(s) for an application, such as loss, latency, or jitter. Similarly, a tunnel is also mapped to the type of SLA that is satisfies, based on the switching fabric that it uses. During runtime, the SD-WAN edge router then maps the application traffic to an appropriate tunnel. Currently, the mapping of SLAs between applications and tunnels is performed manually by an expert, based on their experiences and/or reports on the prior performances of the applications and tunnels.

The emergence of infrastructure as a service (IaaS) and software as a service (SaaS) is having a dramatic impact of the overall Internet due to the extreme virtualization of services and shift of traffic load in many large enterprises. Consequently, a branch office or a campus can trigger massive loads on the network.

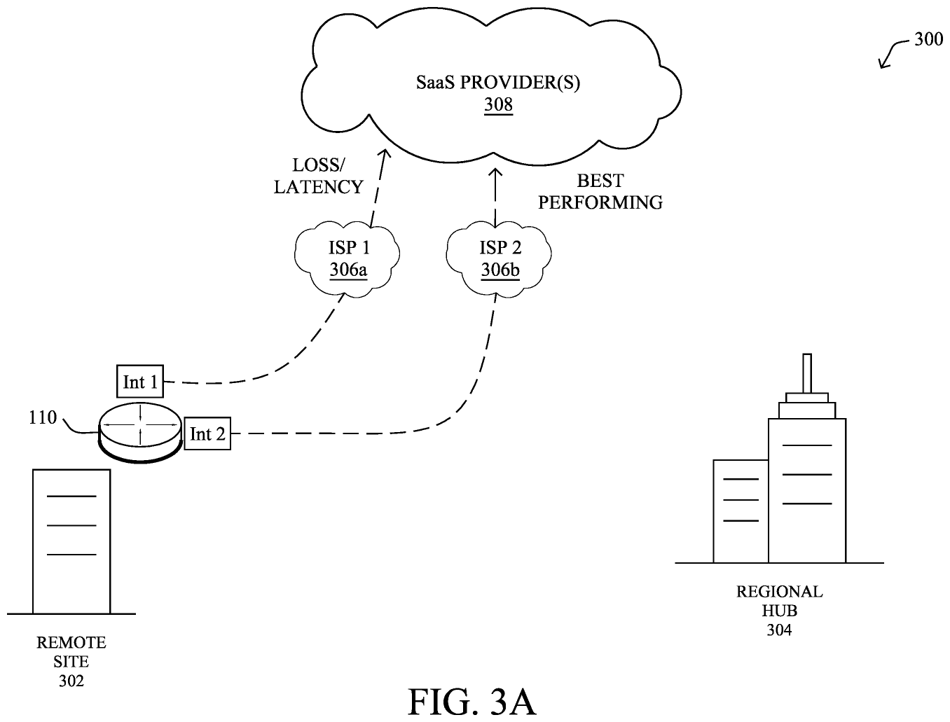

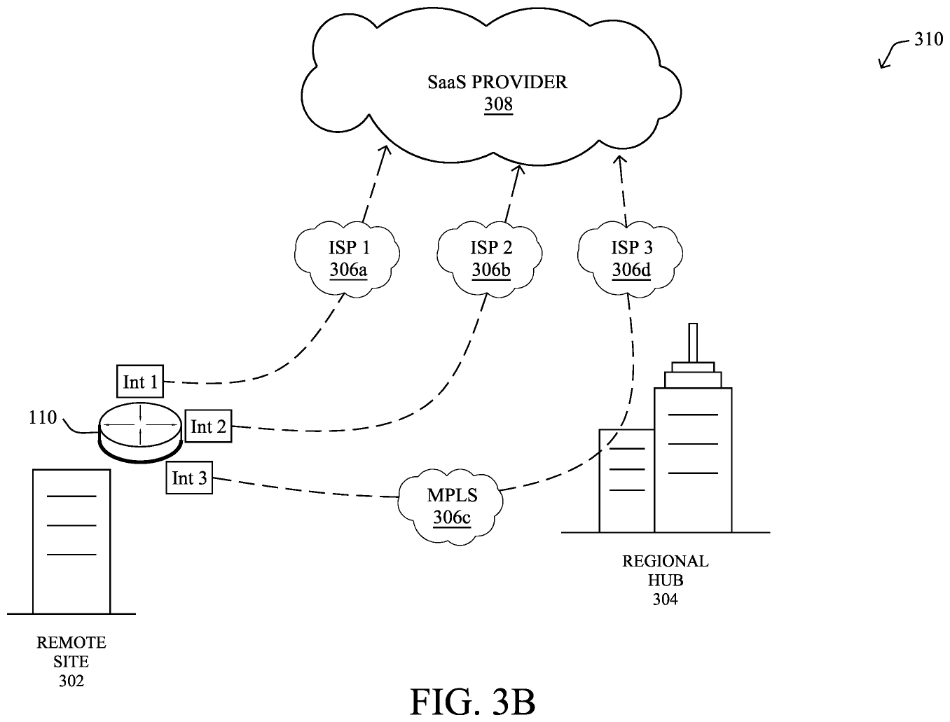

FIGS. 3A-3B illustrate example network deployments 300, 310, respectively. As shown, a router 110 (e.g., a device 200) located at the edge of a remote site 302 may provide connectivity between a local area network (LAN) of the remote site 302 and one or more cloud-based, SaaS providers 308. For example, in the case of an SD-WAN, router 110 may provide connectivity to SaaS provider(s) 308 via tunnels across any number of networks 306. This allows clients located in the LAN of remote site 302 to access cloud applications (e.g., Office 365™, Dropbox™, etc.) served by SaaS provider(s) 308.

As would be appreciated, SD-WANs allow for the use of a variety of different pathways between an edge device and an SaaS provider. For example, as shown in example network deployment 300 in FIG. 3A, router 110 may utilize two Direct Internet Access (DIA) connections to connect with SaaS provider(s) 308. More specifically, a first interface of router 110 (e.g., a network interface 210, described previously), Int 1, may establish a first communication path (e.g., a tunnel) with SaaS provider(s) 308 via a first Internet Service Provider (ISP) 306a, denoted ISP 1 in FIG. 3A. Likewise, a second interface of router 110, Int 2, may establish a backhaul path with SaaS provider(s) 308 via a second ISP 306b, denoted ISP 2 in FIG. 3A.

FIG. 3B illustrates another example network deployment 310 in which Int 1 of router 110 at the edge of remote site 302 establishes a first path to SaaS provider(s) 308 via ISP 1 and Int 2 establishes a second path to SaaS provider(s) 308 via a second ISP 306b. In contrast to the example in FIG. 3A, Int 3 of router 110 may establish a third path to SaaS provider(s) 308 via a private corporate network 306c (e.g., an MPLS network) to a private data center or regional hub 304 which, in turn, provides connectivity to SaaS provider(s) 308 via another network, such as a third ISP 306d.

Regardless of the specific connectivity configuration for the network, a variety of access technologies may be used (e.g., ADSL, 4G, 5G, etc.) in all cases, as well as various networking technologies (e.g., public Internet, MPLS (with or without strict SLA), etc.) to connect the LAN of remote site 302 to SaaS provider(s) 308. Other deployments scenarios are also possible, such as using Colo, accessing SaaS provider(s) 308 via Zscaler or Umbrella services, and the like.

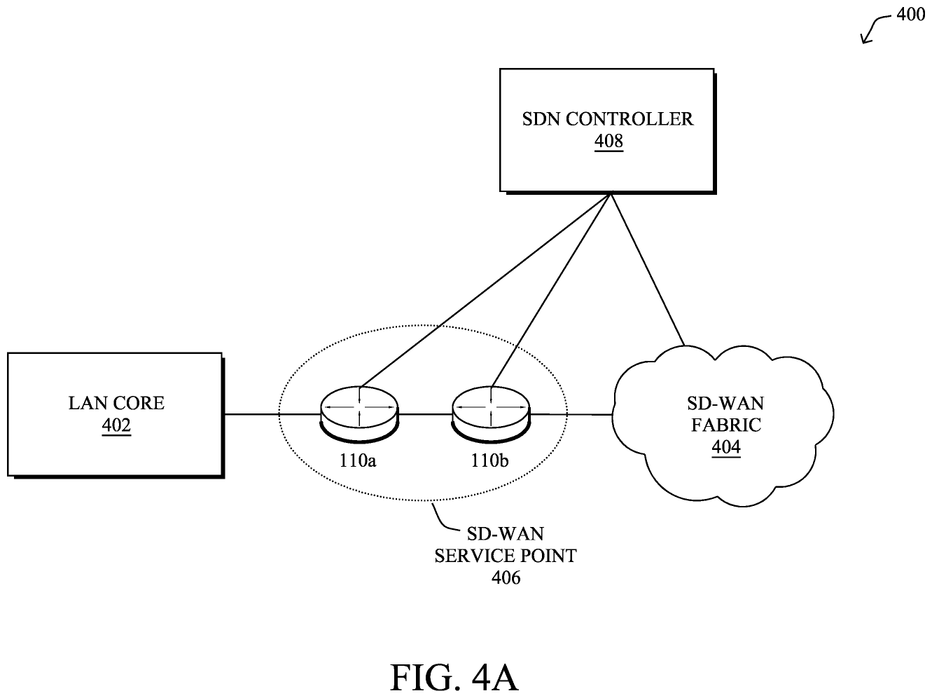

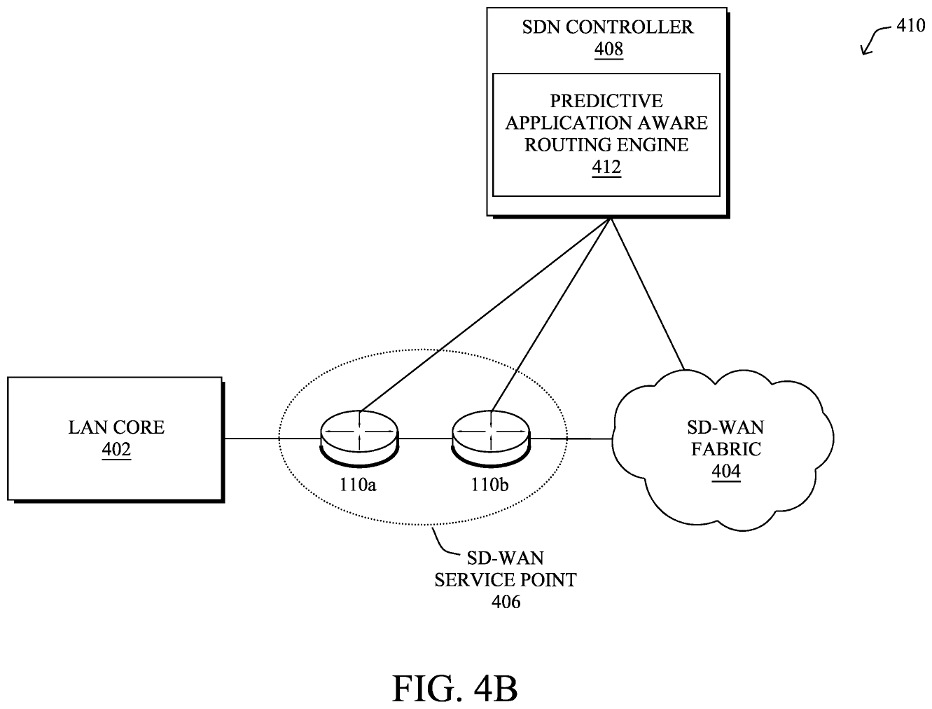

FIG. 4A illustrates an example SDN implementation 400, according to various embodiments. As shown, there may be a LAN core 402 at a particular location, such as remote site 302 shown previously in FIGS. 3A-3B. Connected to LAN core 402 may be one or more routers that form an SD-WAN service point 406 which provides connectivity between LAN core 402 and SD-WAN fabric 404. For instance, SD-WAN service point 406 may comprise routers 110a-110b.

Overseeing the operations of routers 110a-110b in SD-WAN service point 406 and SD-WAN fabric 404 may be an SDN controller 408. In general, SDN controller 408 may comprise one or more devices (e.g., devices 200) configured to provide a supervisory service, typically hosted in the cloud, to SD-WAN service point 406 and SD-WAN fabric 404. For instance, SDN controller 408 may be responsible for monitoring the operations thereof, promulgating policies (e.g., security policies, etc.), installing or adjusting IPsec routes/tunnels between LAN core 402 and remote destinations such as regional hub 304 and/or SaaS provider(s) 308 in FIGS. 3A-3B, and the like.

As noted above, a primary networking goal may be to design and optimize the network to satisfy the requirements of the applications that it supports. So far, though, the two worlds of “applications” and “networking” have been fairly siloed. More specifically, the network is usually designed in order to provide the best SLA in terms of performance and reliability, often supporting a variety of Class of Service (CoS), but unfortunately without a deep understanding of the actual application requirements. On the application side, the networking requirements are often poorly understood even for very common applications such as voice and video for which a variety of metrics have been developed over the past two decades, with the hope of accurately representing the Quality of Experience (QoE) from the standpoint of the users of the application.

More and more applications are moving to the cloud and many do so by leveraging an SaaS model. Consequently, the number of applications that became network-centric has grown approximately exponentially with the raise of SaaS applications, such as Office 365, ServiceNow, SAP, voice, and video, to mention a few. All of these applications rely heavily on private networks and the Internet, bringing their own level of dynamicity with adaptive and fast changing workloads. On the network side, SD-WAN provides a high degree of flexibility allowing for efficient configuration management using SDN controllers with the ability to benefit from a plethora of transport access (e.g., MPLS, Internet with supporting multiple CoS, LTE, satellite links, etc.), multiple classes of service and policies to reach private and public networks via multi-cloud SaaS.

Application aware routing usually refers to the ability to rout traffic so as to satisfy the requirements of the application, as opposed to exclusively relying on the (constrained) shortest path to reach a destination IP address. Various attempts have been made to extend the notion of routing, CSPF, link state routing protocols (ISIS, OSPF, etc.) using various metrics (e.g., Multi-topology Routing) where each metric would reflect a different path attribute (e.g., delay, loss, latency, etc.), but each time with a static metric. At best, current approaches rely on SLA templates specifying the application requirements so as for a given path a tunnel) to be “eligible” to carry traffic for the application. In turn, application SLAs are checked using regular probing. Other solutions compute a metric reflecting a particular network characteristic (e.g., delay, throughput, etc.) and then selecting the supposed ‘best path,’ according to the metric.

The term ‘SLA failure’ refers to a situation in which the SLA for a given application, often expressed as a function of delay, loss, or jitter, is not satisfied by the current network path for the traffic of a given application. This leads to poor QoE from the standpoint of the users of the application. Modern SaaS solutions like Viptela, CloudonRamp SaaS, and the like, allow for the computation of per application QoE by sending HyperText Transfer Protocol (HTTP) probes along various paths from a branch office and then route the application's traffic along a path having the best QoE for the application. At a first sight, such an approach may solve many problems. Unfortunately, though, there are several shortcomings to this approach:
The SLA for the application is ‘guessed,’ using static thresholds.
Routing is still entirely reactive: decisions are made using probes that reflect the status of a path at a given time, in contrast with the notion of an informed decision.
SLA failures are very common in the Internet and a good proportion of them could be avoided (e.g., using an alternate path), if predicted in advance.

In various embodiments, the techniques herein allow for a predictive application aware routing engine to be deployed, such as in the cloud, to control routing decisions in a network. For instance, the predictive application aware routing engine may be implemented as part of an SDN controller (e.g., SDN controller 408) or other supervisory service, or may operate in conjunction therewith. For instance, FIG. 4B illustrates an example 410 in which SDN controller 408 includes a predictive application aware routing engine 412 (e.g., through execution of process 244 and/or process 248). Further embodiments provide for predictive application aware routing engine 412 to be hosted on a router 110 or at any other location in the network.

During execution, predictive application aware routing engine 412 makes use of a high volume of network and application telemetry (e.g., from routers 110a-110b, SD-WAN fabric 404, etc.) so as to compute statistical and/or machine learning models to control the network with the objective of optimizing the application experience and reducing potential down times. To that end, predictive application aware routing engine 412 may compute a variety of models to understand application requirements, and predictably route traffic over private networks and/or the Internet, thus optimizing the application experience while drastically reducing SLA failures and downtimes.

In other words, predictive application aware routing engine 412 may first predict SLA violations in the network that could affect the QoE of an application (e.g., due to spikes of packet loss or delay, sudden decreases in bandwidth, etc.). In turn, predictive application aware routing engine 412 may then implement a corrective measure, such as rerouting the traffic of the application, prior to the predicted SLA violation. For instance, in the case of video applications, it now becomes possible to maximize throughput at any given time, which is of utmost importance to maximize the QoE of the video application. Optimized throughput can then be used as a service triggering the routing decision for specific application requiring highest throughput, in one embodiment.

Predictive application aware routing engine 412 may also identify trend changes in the network KPIs of a path by utilizing several probes that measure path health (e.g., loss, latency and jitter). In turn, the predictive routing engine utilizes statistical and/or machine learning techniques to predict such path deterioration in the future (e.g., predict SLA violations) and generate routing “patches” (e.g., policies) that proactively reroute application traffic before an SLA violation occurs.

One of the main challenges of predictive routing lies in the ability to accurately perform predictions of SLA violations. Generally speaking, the SLA violation predictions should be made with high recall, for the solution to be effective. However, recall is not the only consideration. Indeed, in some instances, it might also be acceptable not to predict an SLA violation and fall back to a reactive routing approach whereby SLAs are checked thanks to probing and the traffic is rerouted only when an actual SLA violation is detected.

Precision represents another performance metric for the SLA violation predictions, which can be particularly critical in situations in which the number of total positive examples is low (e.g., are rare events). Indeed, even a small number of false positives can strongly affect the precision, when the number of true positives is low. Furthermore, the traffic may be unnecessarily rerouted onto a path that may eventually not meet the SLA. In some embodiments, this can be mitigated against by also forecasting whether the new path will violate the SLA. However, rerouting traffic onto the new path will unavoidably change the conditions, including in ways that could cause the SLA to be violated. This can be doubly problematic in situations in which the original path does not exhibit the predicted SLA violation, meaning that the predictive reroute actually made things worse.

By way of example of predictive application aware routing, assume that there is application traffic that is routed along a particular network path (e.g., a tunnel in an SDN) and predicted to experience an SLA violation or, more generally, a decrease in its associated QoE. For instance, assume that path A is forecasted to violate the following SLA for voice traffic in two hours: (latency ≤150 ms, loss ≤3%, and jitter ≤30 ms). In such a case, the routing policy may be patched temporarily on the edge router so that all voice traffic is routed onto a path B, thus avoiding the predicted disruption. However, there is no guarantee that path B is indeed capable of carrying the voice traffic usually carried by path A. Indeed, the rerouting itself might then cause a violation, possibly even worse, on path B, both for the existing traffic on path B and the rerouted traffic from path A.

### —Model Counterfactual Scenarios of SLA Violations Along Network Paths—

The techniques introduced herein allow for the forecasting of so-called “counterfactual” scenarios, that is, predicting what would happen under different circumstances than those actually observed. For instance, the proposed forecasting can answer questions such as “if 3.4 Mbps of voice traffic were rerouted onto path B, would the SLA of the voice traffic be violated?” In contrast to traditional forecasting, this allows for the modeling of what-if scenarios. To this end, various mechanisms and methods are introduced to collect data, train models, and forecast the outcome of counterfactual outcomes. Note that such an issue is notoriously known as being very challenging and more than one technique may be used to achieve that objective.

Illustratively, the techniques described herein may be performed by hardware, software, and/or firmware, such as in accordance with counterfactual evaluation process 248, which may include computer executable instructions executed by the processor 220 (or independent processor of interfaces 210) to perform functions relating to the techniques described herein (e.g., in conjunction with routing process 244).

Specifically, according to various embodiments, a device obtains traffic telemetry data regarding a first path in a network and an alternate path in the network. The device predicts, based on the traffic telemetry data, an amount of traffic for an application that is expected at a particular time. The device makes, based on the traffic telemetry data and on the amount of traffic for the application that is predicted to be expected at the particular time, a counterfactual prediction as to whether the alternate path would violate a service level agreement associated with the traffic, should the traffic be routed via the alternate path at the particular time. The device causes, based on the counterfactual prediction, the traffic for the application to be rerouted from the first path in the network to the alternate path, prior to the particular time.

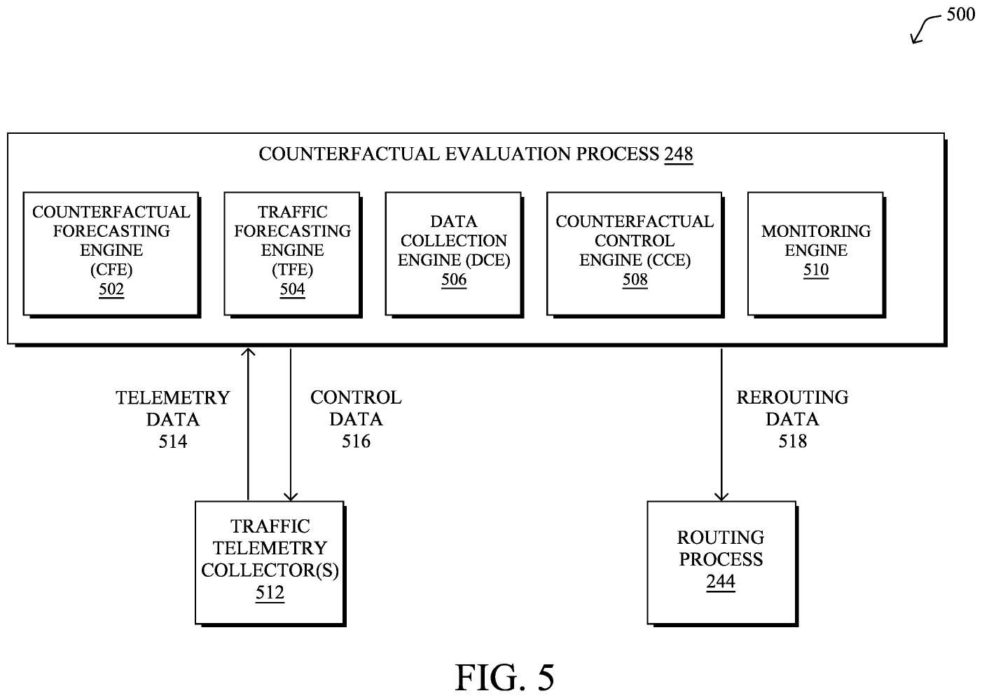

Operationally, FIG. 5 illustrates an example architecture 500 for evaluating counterfactual routing scenarios in a network, according to various embodiments. At the core of architecture 500 is counterfactual evaluation process 248, which may be executed by a supervisory device of a network or another device in communication therewith. For instance, counterfactual evaluation process 248 may be executed by an SDN controller (e.g., SDN controller 408 in FIG. 4), a particular networking device in the network (e.g., a router, etc.), or another device in communication therewith. As shown, counterfactual evaluation process 248 may include any or all of the following components: a counterfactual forecasting engine 502, a traffic forecasting engine 504, a data collection engine 506, a counterfactual control engine 508, and/or a monitoring engine 510. As would be appreciated, the functionalities of these components may be combined or omitted, as desired. In addition, these components may be implemented on a singular device or in a distributed manner, in which case the combination of executing devices can be viewed as their own singular device for purposes of executing counterfactual evaluation process 248.

During execution, counterfactual evaluation process 248 may obtain telemetry data 514 from any number of traffic telemetry collectors 512 for the network path(s) under scrutiny. For instance, telemetry data 514 may comprise NetFlow records, IPFIX records, path probing results, such as from Bidirectional Forwarding Detection (BFD) probing, or other telemetry data indicative of the performance of a particular path (e.g., in terms of delay, jitter, packet loss, etc.). Telemetry data 514 may also include application-specific information regarding the various applications whose traffic is conveyed by a particular path in the network. In some instances, counterfactual evaluation process 248 may also provide control over the collection of telemetry data 514 by traffic telemetry collectors 512, such as by issuing control data 516 to traffic telemetry collectors 512.

As would be appreciated, a prerequisite to counterfactual modeling is the collection of relevant telemetry data 514. To this end, two possibilities exist with respect to the collection of telemetry data 514:
Passive data collection whereby traffic telemetry collectors 512 collect telemetry data 514 from the network without any control by counterfactual evaluation process 248. In this situation, actively probing a path is typically not possible, to determine whether that path could support a given traffic load under specific conditions (e.g., type of traffic, time of the day/week, etc.).
Active data collection whereby traffic telemetry collectors 512 collect telemetry data 514 from the network under the control of counterfactual evaluation process 248, to some extent, through control data 516. For instance, control data 516 sent by counterfactual evaluation process 248 to traffic telemetry collectors 512 may indicate that traffic telemetry collectors 512 should actively probe a particular network path (e.g., tunnel) with arbitrary traffic in a specific situation.

As would be appreciated, counterfactual evaluation process 248 may rely on either or both of passively collected telemetry data 514 and actively collected telemetry data 514. Indeed, active data collection may sometimes be needed to achieve satisfactory performance of the forecasting, despite its additional resource consumption in the network.

In various embodiments, counterfactual evaluation process 248 may include counterfactual forecasting engine (CFE) 502 that is responsible for evaluating counterfactual routing scenarios. For instance, CFE 502 may be configured to answer the question, “Given a set of conditions C at a time T, what is the likelihood that path P violates SLA template A?” Here, the set of conditions C may be given by traffic breakdown of the form of a dictionary, such as {“voice”: 2.3 Mbps, “https”: 14 Kbps, “dns”: 234 bps}, where “voice,” “https,” and “dns” are different types of application traffic. Likewise, the time T may represent an interval given by a start and end timestamp.

During execution, CFE 502 may predict a probability, denoted Pr_{C,T}[A], using a machine learning-based prediction model, in various embodiments. Such a prediction model may take the form of a liner model, neural network, or other suitable form of prediction model (e.g., a statistical model, etc.). The prediction model may, for instance, take into consideration information such as, but not limited to, any or all of the following historical information: service provider (SP) information, the location of the path, router information (e.g., its model, etc.), or the like. In a more advanced embodiment, the prediction model of CFE 502 may also take into account the specific traffic type (e.g., voice, DNS, HTTPS, etc.), coupled with the QoS support on a given interface (e.g., retrieved using the SDN controller). In this case, for instance, the prediction model of CFE 502 may compute PrC,T[A] by considering the traffic class for the set of conditions C.

In various embodiments, counterfactual evaluation process 248 may also include traffic forecasting engine (TFE) 504, which is configured to predict the traffic conditions on a path at a given point in time n the future. To this end, TFE 504 may also include a machine learning-based prediction model such as a time-series model that takes the form of a linear autoregressive model, neural network model, or any other suitable form of model (e.g., statistical model, etc.). In a simple embodiment, the prediction model of TFE 504 may predict a scalar value that is the expected bitrate on a given path P at a given time T. In more complex embodiments, the prediction model of TFE 504 may predict the expected bitrate for various types of application traffic. Since traffic is typically quite seasonal, TFE 504 may also make use of historical traffic statistics, in order to infer future path usage.

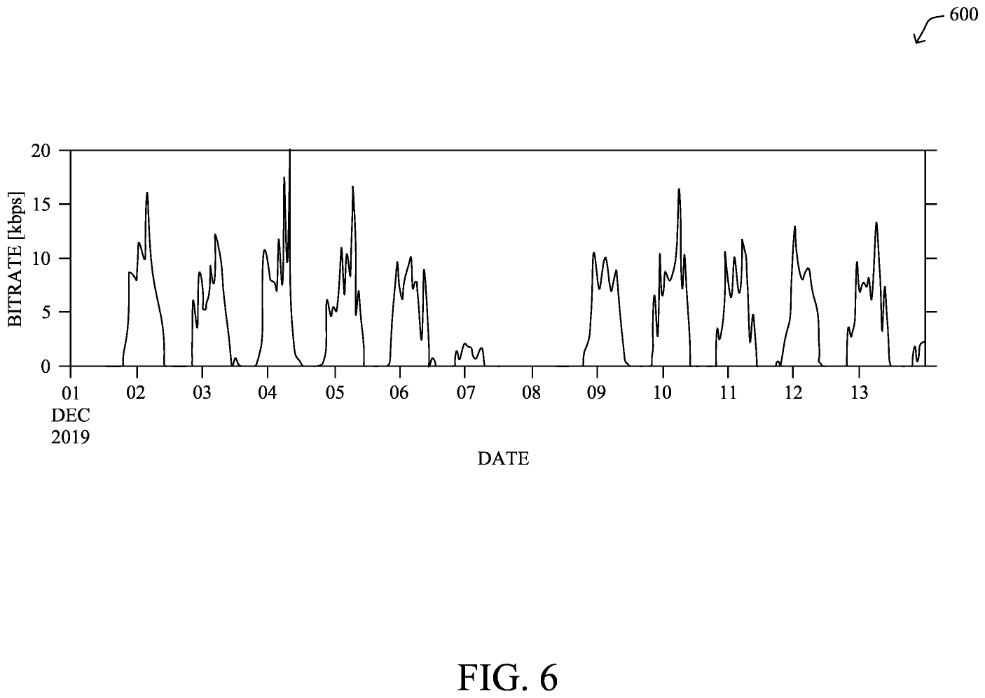

FIG. 6 illustrates an example plot 600 of the traffic profile along a network path over time, according to various embodiments. More specifically, plot 600 shows the bitrate (in kbps) of a particular network path (e.g., an SD-WAN tunnel) over the course of two weeks: Sunday, Dec. 1, 2019 through Friday, Dec. 13, 2019. As can be seen, there are both daily and weekly seasonal patterns, with the bitrate increasing drastically during the daytime of weekdays and remaining essentially zero at night and on Sundays.

Referring again to FIG. 5, the prediction model of CFE 502 may take as input telemetry data 514 that has been collected passively by traffic telemetry collectors 512, well as actively, in some embodiments. To this end, counterfactual evaluation process 248 may also include data collection engine (DCE) 506 that is responsible for overseeing the collection of telemetry data 514 and issuing control data 516 to traffic telemetry collectors 512, as needed. Based on telemetry data 514, DCE 506 may keep track of the traffic per application and QoS metrics such as loss, latency, and jitter, for a given network path. Here, the overall goal of DCE 506 is to provide CFE 502 with as much variety as possible, in terms of telemetry data 514. In particular, if a given path P is a candidate backup path for rerouting that never violates the SLA of interest, but path P also never carried any traffic, CFE 502 cannot build an accurate model of what will happen, should the application traffic be rerouted onto path P. To solve this, DCE 506 may generate routing patches that force traffic to be rerouted to path P, anyways. In various embodiments, DCE 506 can do this in multiple ways, such as by providing rerouting data 518 to routing process 244, as follows:
DCE 506 may ask the edge router to use path P for a subset of the application traffic.
DCE 506 may ask the router to duplicate a subset of the traffic on path P, with a marker that requests the destination to drop the duplicate traffic.
DCE 506 may ask the router to use path P as its first backup when a violation is detected on the primary path.

In all of the above cases, the rerouting patches generated by DCE 506 may be temporary in nature. In addition, in some embodiments, DCE 506 may create conditional routing patches, which are implemented only when some specific conditions are met (e.g., voice (raffle reaches 1 Mbps). In other embodiments, DCE 506 may rely on forecasts from TFE 504, in order to schedule the reroutes at times where the traffic is expected to match conditions that maximize the variety of the resulting telemetry data 514.

Now, as DCE 506 triggers more and more reroutes via rerouting data 518, the variety of telemetry data 514 increases and CFE 502 will become more capable at determining the probability of SLA violation in various circumstances.

In various embodiments, counterfactual evaluation process 248 may also include counterfactual control engine (CCE) 508 that uses the prediction model trained by CFE 502 to make rerouting decisions. For every path P under scrutiny, CCE 508 may query TFE 504, to check whether any traffic is expected at a given time T. If so, CCE 508 then queries CFE 502, to check whether there is a risk of an SLA violation for a particular class of application traffic. If there is, CCE 508 may then query CFE 502 for all alternate paths P′, P″, etc. and can make a rerouting decision, if the likelihood of an SLA violation on these alternate path(s) is lower than for the primary path P. Note that CCE 508 may query CFE 502 to evaluate whether a given path can satisfy a new set of conditions C′, while taking into account potential new traffic to reroute and the existing traffic at a given time. In other words, the modeling by CFE 502 also accounts for the traffic that is expected to be rerouted onto these alternative paths, in order to evaluate the necessity of a reroute. If CCE 508 determines that a rerouting should be performed, it may initiate the rerouting by sending rerouting data 518 to routing process 244, which carries out the rerouting operation.

In more complex embodiments, CCE 508 may also use CFE 502 to evaluate whether only a subset of the application traffic should be rerouted. For instance, assuming that the expected traffic on the primary path is as follows: {“voice”: 2.3 Mbps, “dropbox”: 25 Mbps, “dns”: 234 bps}, CCE 508 may query CFE 502, to evaluate a scenario where the Dropbox traffic is defensively rerouted onto the backup path and predict whether doing so would avoid the SLA violation. In this case, CCE 508 would, therefore, protect the voice traffic by re-routing a bulk transfer on an alternate path. To achieve this, CCE 508 may use a combinatorial search that considers every application as an individual entity that it can assign to different paths. For every combination, CCE 508 may query CFE 502, to assess the likelihood of a violation on all paths. Of course, different SLA templates may be used for different types of applications, such that the overall objective of the optimizer is to minimize the number of impacted sessions, possibly weighted by criticality of the applications.

In yet another embodiment, CCE 508 may also use CFE 502 to evaluate whether only a subset of the traffic should be rerouted, considering the impact on lower priority traffic. For example, consider the case where a traffic T1 is expected to experience an SLA violation on path A, and there is an alternate path B such that CFE 502 predicts that no such SLA violation would occur when rerouting T1 onto path B, except for a subset of existing traffic along B of lower priority (sharing the same QoS). In this case, it may still be acceptable and/or preferable to reroute T1 along path B at the cost of impacting lower priority traffic already existing on path B.

In some embodiments, counterfactual evaluation process 248 may also include monitoring engine 510, which is responsible for monitoring the output of CCE 508 and provide indications to DCE 506 as to which scenarios require additional exploration and telemetry data 514. Monitoring engine 510 may, for instance, evaluate the input and output of CCE 508, the paths suggested by CFE 502, the predicted traffic from TFE 504, the application, the risk of violation, and/or the ground truth (e.g., whether the SLA violation actually occurred). In one embodiment, monitoring engine 510 may first list paths, traffic regimes, and context for which CFE 502 has performed incorrect predictions, that is, that a path violates an SLA (Pr_{C,T}[A]). Monitoring engine 510 may do so, for instance, by ranking the top <paths, application and traffic-regime> combinations with high incorrect predictions. Based on this, monitoring engine 510 may then instruct DCE 506 to initiate more active probing on these paths for the selected applications and traffic regimes.

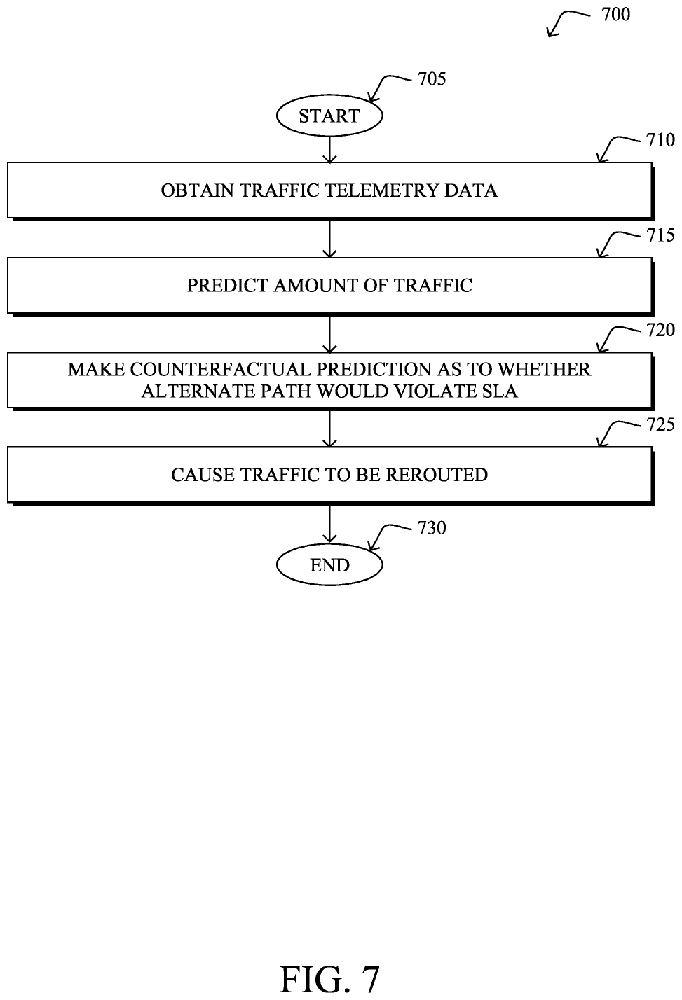

FIG. 7 illustrates an example simplified procedure for evaluating counterfactual routing scenarios in a network, in accordance with one or more embodiments described herein. For example, a non-generic, specifically configured device (e.g., device 200), such as a networking device (e.g., a router, an SDN controller for an SD-WAN, etc.), or a device in communication therewith, may perform procedure 700 by executing stored instructions (e.g., counterfactual evaluation process 248 and/or routing process 244). The procedure 700 may start at step 705, and continues to step 710, where, as described in greater detail above, the device may obtain traffic telemetry data regarding a first path and an alternate path in the network. As noted above, the device may do so in a passive manner and/or in an active manner, such as by instructing a router in the network to actively probe a path. For instance, the device may instruct the router to reroute or duplicate a portion of traffic for an application onto the alternate path. In other cases, the device may instruct the router to set the alternate path as a first backup path for the first path, so that the application traffic will be rerouted onto it, should the first path violate the SLA of the traffic. Example traffic telemetry data may indicate path QoS metrics (e.g., delay, loss, jitter, etc.), characteristics of the application traffic (e.g., the identity of the application, the bitrate of the traffic, the priority of the traffic, etc.), other path characteristics (e.g., the model of the edge router associated with the path, geographic location information for the path, etc.), combinations thereof, or the like.

At step 715, as detailed above, the device may predict, based on the traffic telemetry data, an amount of the application traffic that is expected at a particular time. As noted, application traffic often exhibits seasonal profiles, such as on an hourly, daily, or weekly basis. Accordingly, the device may train and use a prediction model to predict the amount of expected application traffic at a particular time in the future. For instance, if no traffic was observed on the prior n-number of Sundays, the model may predict that there will also be no traffic observed on the upcoming Sunday.

At step 720, the device may make a counterfactual prediction as to whether the alternate path would violate a service level agreement associated with the traffic, should the traffic be routed via the alternate path at the particular time, as described in greater detail above. In various embodiments, the device may base the counterfactual prediction on the traffic telemetry data and on the amount of traffic that it predicted to be expected at the particular time. In other words, the counterfactual prediction may predict the effects of rerouting the traffic onto the alternate path, even if that traffic is not currently being routed via the alternate path. In some embodiments, the device may use a machine learning-based prediction model to make such a prediction.

At step 725, as detailed above, the device may cause, based on the counterfactual prediction, the traffic for the application to be rerouted from the first path to the alternate path, prior to the particular time. In some embodiments, the device may do so by opting to reroute a subset of the traffic to the alternate path. In other embodiments, the device may determine that rerouting the traffic onto the alternate path will cause an SLA associated with lower priority traffic on the alternate path to be violated, but still proceed with the rerouting, anyways. Procedure 700 then ends at step 730.

It should be noted that while certain steps within procedure 700 may be optional as described above, the steps shown in FIG. 7 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, dramatically improve the performance of Predictive Application Aware Routing (PAAR) engines by combining a traffic forecaster and a counterfactual forecast that is capable of estimating the likelihood of a violation on a given path for various traffic conditions. Doing so allows a control engine to make much more robust and subtle routing decisions, including defensive reroutes, to protect critical traffic instead of merely rerouting the whole traffic of a link to alternate paths that may not be able to support that much traffic.

While there have been shown and described illustrative embodiments that provide for modeling counterfactual routing scenarios, it is to be understood that various other adaptations and modifications may be made within the spirit and scope of the embodiments herein. For example, while certain embodiments are described herein with respect to using certain models for purposes of predicting SLA violations, the models are not limited as such and may be used for other types of predictions, in other embodiments. In addition, while certain protocols are shown, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

1. A method comprising:
obtaining, by a device, traffic telemetry data regarding a first path in a network and an alternate path in the network;
predicting, by the device and based on the traffic telemetry data, an amount of traffic for an application that is expected at a particular time;
making, by the device and based on the traffic telemetry data and on the amount of traffic for the application that is predicted to be expected at the particular time, a counterfactual prediction as to whether the alternate path would violate a service level agreement associated with the traffic, should the traffic be routed via the alternate path at the particular time; and
causing, by the device and based on the counterfactual prediction indicating that the alternate path would not violate the service level agreement, the traffic for the application to be rerouted from the first path in the network to the alternate path, prior to the particular time.

2. The method as in claim 1, wherein the network comprises a software-defined wide area network and wherein the first path or the alternate path comprises a network tunnel.

3. The method as in claim 1, further comprising:
determining that rerouting the traffic onto the alternate path will cause a service level agreement associated lower priority traffic on the alternate path to be violated.

4. The method as in claim 1, wherein the device makes the counterfactual prediction as to whether the alternate path would violate the service level agreement associated with the traffic using a machine learning-based prediction model.

5. The method as in claim 1, wherein obtaining the traffic telemetry data comprises:
instructing a router in the network to perform active probing of the alternate path.

6. The method as in claim 5, wherein active probing of the alternate path comprises rerouting a portion of the traffic onto the alternate path.

7. The method as in claim 5, wherein active probing of the alternate path comprises duplicating a portion of the traffic onto the alternate path.

8. The method as in claim 5, wherein active probing of the alternate path comprises setting the alternate path as a first backup path for the first path.

9. The method as in claim 1, further comprising:
instructing a router in the network to perform active probing of the first path, based on a determination that the first path would not have violated the service level agreement.

10. The method as in claim 1, wherein the device causes a subset of the traffic for the application to be rerouted from the first path in the network to the alternate path.

11. An apparatus, comprising:
one or more network interfaces;
a processor coupled to the one or more network interfaces and configured to execute one or more processes; and
a memory configured to store a process that is executable by the processor, the process when executed configured to:
obtain traffic telemetry data regarding a first path in a network and an alternate path in the network;
predict, based on the traffic telemetry data, an amount of traffic for an application that is expected at a particular time;
make, based on the traffic telemetry data and on the amount of traffic for the application that is predicted to be expected at the particular time, a counterfactual prediction as to whether the alternate path would violate a service level agreement associated with the traffic, should the traffic be routed via the alternate path at the particular time; and
cause, based on the counterfactual prediction indicating that the alternate path would not violate the service level agreement, the traffic for the application to be rerouted from the first path in the network to the alternate path, prior to the particular time.

12. The apparatus as in claim 11, wherein the network comprises a software-defined wide area network and wherein the first path or the alternate path comprises a network tunnel.

13. The apparatus as in claim 11, wherein the process when executed is further configured to:
determine that rerouting the traffic onto the alternate path will cause a service level agreement associated lower priority traffic on the alternate path to be violated.

14. The apparatus as in claim 11, wherein the apparatus makes the counterfactual prediction as to whether the alternate path would violate the service level agreement associated with the traffic using a machine learning-based prediction model.

15. The apparatus as in claim 11, wherein the apparatus obtains the traffic telemetry data by:
instructing a router in the network to perform active probing of the alternate path.

16. The apparatus as in claim 15, wherein active probing of the alternate path comprises rerouting a portion of the traffic onto the alternate path.

17. The apparatus as in claim 15, wherein active probing of the alternate path comprises duplicating a portion of the traffic onto the alternate path.

18. The apparatus as in claim 15, wherein active probing of the alternate path comprises setting the alternate path as a first backup path for the first path.

19. The apparatus as in claim 11, wherein the process when executed is further configured to:
instruct a router in the network to perform active probing of the first path, based on a determination that the first path would not have violated the service level agreement.

20. A tangible, non-transitory, computer-readable medium storing program instructions that cause a device to execute a process comprising:
obtaining, by the device, traffic telemetry data regarding a first path in a network and an alternate path in the network;
predicting, by the device and based on the traffic telemetry data, an amount of traffic for an application that is expected at a particular time;
making, by the device and based on the traffic telemetry data and on the amount of traffic for the application that is predicted to be expected at the particular time, a counterfactual prediction as to whether the alternate path would violate a service level agreement associated with the traffic, should the traffic be routed via the alternate path at the particular time; and
causing, by the device and based on the counterfactual prediction indicating that the alternate path would not violate the service level agreement, the traffic for the application to be rerouted from the first path in the network to the alternate path, prior to the particular time.
